(19) United States
(12) Patent Application Publication
(10) Pub. No.: US 2009/0009085 A1
(43) Pub. Date: Jan. 8, 2009

(54) Tld Low-Pressure Gas Discharge Lamp

(75) Inventors: Ekachai Kriengkomol, Eindhoven (NL); Panithan Sutteesatitporn, Bangkok (TH); Duangnapa Somsurawanit, Bangkok (TH)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/161,879

(22) PCT Filed: Jan. 18, 2007
(86) PCT No.: PCT/IB07/50163

§ 371 Date: Jul. 23, 2008

(30) Foreign Application Priority Data
Jan. 25, 2006 (EP) 06100809.0

(51) Int. Cl. H01J 61/35

(52) U.S. Cl. 313/635

(57) ABSTRACT

The invention relates to a low-pressure mercury vapor discharge lamp (2,4) having a first vessel (6) enclosing a discharge space, and a second vessel surrounding the first vessel. The second vessel (22) comprises a polymer material, or the second vessel (16) comprises a glass material and is at least partially coated with an infrared-reflective material (18) on the side facing the first vessel. A stagnant layer of gas is created between the first and the second vessel, reducing the heat transfer from the discharge space to the surrounding area of the lamp. As a result, the light output is improved at relatively low ambient temperatures.

### TECHNICAL FIELD

The invention relates to a low-pressure mercury vapor discharge lamp comprising: a first, light-transmitting vessel enclosing, in a gastight manner, a discharge space; the first vessel comprising discharge means for maintaining a discharge in the discharge space.

### BACKGROUND ART

In mercury vapor discharge lamps, mercury constitutes the primary component for the generation of ultraviolet (UV) light. A luminescent layer comprising a luminescent material may be present on an inner wall of the discharge vessel to convert UV light to light of other wavelengths, for example to UV-B and UV-A for tanning purposes or to visible light for general illumination purposes. Such discharge lamps are therefore also referred to as fluorescent lamps. Alternatively, the ultraviolet light generated may be used for manufacturing germicidal lamps (UV-C). The discharge vessel of low-pressure mercury vapor discharge lamps is usually tubular and comprises both elongate and compact embodiments. Generally, the tubular discharge vessel of compact fluorescent lamps comprises a collection of relatively short straight parts having a relatively small diameter, which straight parts are connected together by means of bridge parts or via bent parts. Compact fluorescent lamps are usually provided with an (integrated) lamp cap. Normally, the means for maintaining a discharge in the discharge space are electrodes arranged in the discharge space. In an alternative embodiment, the low-pressure mercury vapor discharge lamp is a so-called electrodeless low-pressure mercury vapor discharge lamp.

Conventional low-pressure mercury vapor discharge lamps have an optimum light output at an ambient temperature of approximately 25° C. At this ambient temperature, the temperature at the cold spot of the lamp is typically 43° C., resulting in a mercury vapor pressure at which the light output of the lamp is optimal. It is a disadvantage of the conventional low-pressure mercury vapor discharge lamp that at ambient temperatures lower than 25° C., the mercury vapor pressure and hence the light output of the lamp is not optimal.

### DISCLOSURE OF INVENTION

An object of the invention is to overcome the above-mentioned disadvantage at least partially.

This object is achieved by means of a low-pressure mercury vapor discharge lamp according to the invention, characterized in that the discharge lamp further comprises a second, light-transmitting vessel having two end sections, the second vessel at least partially coaxially surrounding the first vessel, and being coupled to the first vessel via the two end sections, and the second vessel comprising a polymer material, or the second vessel comprising a glass material, and being at least partially coated with an infrared-reflective material on the side facing the first vessel. A layer of insulating gas, e.g. air, is created between the discharge space and the surrounding area of the lamp, reducing the heat transfer from the discharge space to the surrounding area. In case of a surrounding area with a relatively low temperature, i.e. a temperature lower that 25° C., the reduction in heat transfer to the surrounding area results in an increase of the cold spot temperature in comparison with the conventional lamp, increasing the mercury vapor pressure in the discharge space, and hence increasing the light output of the lamp. Low-pressure mercury vapor discharge lamps according to the invention can be used, for example, in cold stores, refrigerators, or outdoors in places with a relatively low ambient temperature. A further advantage of a low-pressure mercury vapor discharge lamp with a second vessel of a polymer material, for example, polycarbonate (PC), polystyrene (PS) or polymethylmethacrylate (PMMA), is that it is less fragile compared to a second vessel of a glass material. The latter is of importance especially in cold stores for storage of food to reduce the risk of breakdown of the lampin case it falls to the ground or is hit by a hard object for example, which may result in lamp fragments ending up in the stored food. Furthermore, the thermal conductivity coefficient of a polymer material is in general lower than that of a glass material, further reducing the heat transfer to the surrounding area compared to a second vessel of glass. A further advantage of a low-pressure mercury vapor discharge lamp with a second vessel having an infrared-reflective coating on the inside is that heat generated in the discharge space and radiated to the surrounding area is at least partially reflected back to the discharge space, even further reducing the dissipation of heat to the surrounding area.

An embodiment of the low-pressure mercury vapor discharge lamp according to the invention is characterized in that the infrared-reflective material comprises TiO₂, NbO₂ or SnO₂. An embodiment of the low-pressure mercury vapor discharge lamp according to the invention is characterized in that the infrared-reflective material comprises SnO2:F. These materials have a relatively high reflection coefficient for infrared radiation.

An embodiment of the low-pressure mercury vapor discharge lamp according to the invention is characterized in that the coating of infrared-reflective material is formed as a plurality of layers. Multiple layers improve the total infrared reflection.

An embodiment of the low-pressure mercury vapor discharge lamp according to the invention is characterized in that the polymer material comprises an acrylic compound. Acrylic compounds have a good transparency as well as a good endurance.

An embodiment of the low-pressure mercury vapor discharge lamp according to the invention is characterized in that the first vessel is coupled to the second vessel in a gastight manner, and that a space between the first vessel and the second vessel is filled with a gas comprising carbon dioxide. As carbon dioxide has a lower thermal conductivity coefficient compared to air, the heat transfer from the discharge space to the surrounding area of the lamp is further reduced.

### BRIEF DESCRIPTION OF THE DRAWINGS

These and other aspects of the invention are described in more detail with reference to the drawings:

FIG. 1 is a schematic drawing of a first embodiment of the low-pressure mercury vapor discharge lamp according to the invention.

FIG. 2 is a schematic drawing of a second embodiment of the low-pressure mercury vapor discharge lamp according to the invention.

The Figures are purely diagrammatic and not drawn to scale. Notably, some dimensions are shown strongly exaggerated for the sake of clarity. Similar components in the Figures are denoted as much as possible by the same reference numerals.

### DESCRIPTION OF PREFERRED EMBODIMENTS

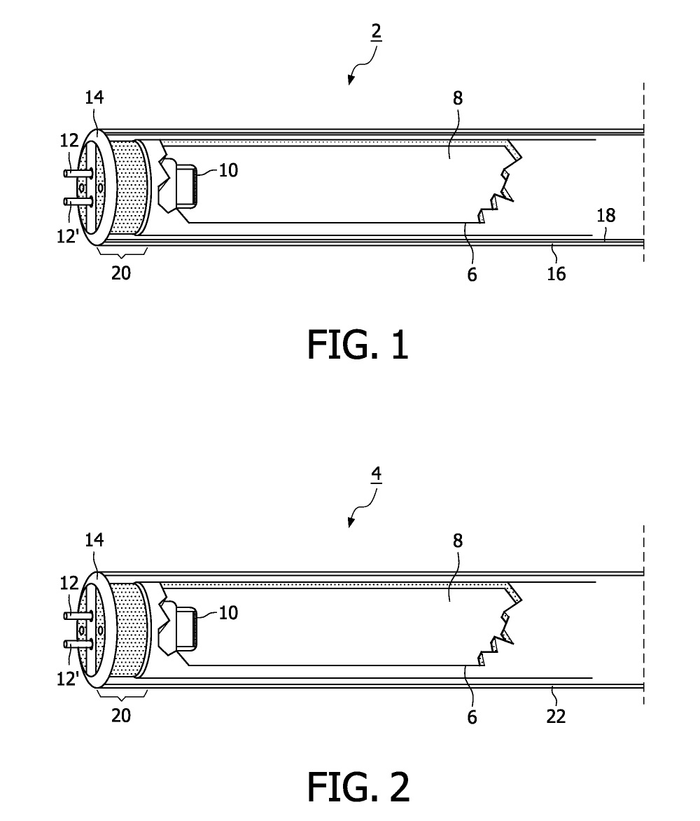

FIG. 1 is a schematic drawing of a first embodiment of the low-pressure mercury vapor discharge lamp according to the invention. FIG. 2 is a schematic drawing of a second embodiment of the low-pressure mercury vapor discharge lamp according to the invention. For clarity reasons, FIGS. 1 and 2 only show a part of the low-pressure mercury vapor discharge lamp. Referring to FIGS. 1 and 2, the low-pressure mercury vapor discharge lamp 2, 4 has a gas discharge vessel 6 that encloses, in a gastight manner, a discharge space 8 containing a filling of mercury and an inert gas mixture, for example argon. In fluorescent discharge lamps, the side of the discharge vessel 6 facing the discharge space 8 is coated with a luminescent layer, not shown, which includes a luminescent material, for example a fluorescent powder, which converts the ultraviolet light generated by fallback of the excited mercury into visible light, for example. In this embodiment, the discharge means for maintaining a discharge in the discharge space 8 are electrodes 10, of which only one is shown. The electrode 10 is a winding of tungsten covered with an electron-emitting substance, in this case a mixture of barium oxide, calcium oxide and strontium oxide. Current-supply conductors, not shown, coupled to the electrodes 10 pass through the end portions of the lamp and issue from the discharge vessel 6 to the exterior. The current-supply conductors are connected to contact pins 12, 12 that are secured to a lamp cap 14, of which only one is shown.

In an alternative embodiment, the low-pressure mercury vapor discharge lamp according to the invention is a so-called electrodeless discharge lamp, in which the discharge means for maintaining a discharge are situated outside a discharge space surrounded by the discharge vessel. Generally, said means are formed by a coil provided with a winding of an electric conductor, with a high-frequency voltage, for example a frequency of approximately 3 MHz, being supplied to said coil, in operation. In general, said coil surrounds a core of a soft-magnetic material. In another alternative embodiment, the low-pressure mercury vapor discharge lamp according to the invention is a so-called capacitively coupled discharge lamp, in which the discharge means for maintaining a discharge are conductive coatings provided at the end sections of the discharge vessel. The conductive coatings act, during operation of the lamp, as capacitive electrodes, between which a discharge extends.

Referring to FIG. 1, the low-pressure mercury vapor discharge lamp 2 further comprises an outer vessel 16 that coaxially surrounds the discharge vessel 6. The outer vessel 16 is made from glass, and the outer vessel 16 is coated with an infrared-reflective coating 18 on the side facing the discharge vessel 6. The end sections 20 of the outer vessel 16, of which only one is shown, are coupled to the discharge vessel 6 via the lamp cap 14. Between the outer vessel 16 and the discharge vessel 6, an insulating layer of air is created, which reduces the heat transfer between the discharge vessel 6 and the surrounding area of the lamp, during operation of the lamp. The infrared-reflective coating 18 reflects infrared radiation back to the discharge vessel 6, thereby even further reducing the heat transfer to the surrounding area of the discharge lamp 2. The infrared-reflective coating 18 may comprise titanium oxide (TiO₂), niobium oxide (NbO₂), tin oxide (SnO₂), or fluorine-doped tin oxide (SnO₂:F), for example.

In the embodiment of the low-pressure mecury vapor discharge lamp of FIG. 2, the outer vessel 22 is made from an acrylic compound, for example, polymethylmethacrylate (PMMA). The outer vessel 22 is mounted to the lamp cap 14 by means of a glue compound, and coupled to the discharge vessel 6 via the lamp cap 14. Between the outer vessel 22 and the discharge vessel 6 an insulating layer of air is created. The outer vessel 22 made from an acrylic compound is less fragile compared to one made from a glass compound. In alternative embodiments different polymer materials are used, for example, polycarbonate (PC) or polystyrene (PS).

In an alternative embodiment of the low-pressure mercury vapor discharge lamp, the outer vessel 16, 22 is connected to the discharge vessel 6 in a gastight manner, for example, by connecting it directly to the discharge vessel 6, or by connecting it to the discharge vessel 6 via the lamp cap 14. The space between the outer vessel 16, 22 and the discharge vessel 6 is filled with carbon dioxide, or alternatively with a mixture of carbon dioxide and air. As the thermal conductivity coefficient of carbon dioxide is lower than that of air, heat transfer from the gas discharge 6 to the surrounding area of the lamp is further reduced in this embodiment. By varying the ratio between air and carbon dioxide, the insulating properties of the stagnant gas layer between the outer vessel 16, 22 and the discharge vessel 6 can be varied.

In an alternative embodiment of the low-pressure mercury vapor discharge lamp, the infrared-reflective coating 18 comprises multiple layers of infrared-reflective material, which improves the reflection of heat in the direction of the discharge space 6.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

1. A low-pressure mercury vapor discharge lamp (2, 4) comprising:
a first, light-transmitting vessel (6) enclosing, in a gastight manner, a discharge space (8),
the first vessel (6) comprising discharge means (10) for maintaining a discharge in the discharge space,
characterized in that the discharge lamp (2, 4) further comprises a second, light-transmitting vessel (16, 22) having two end sections (20), the second vessel at least partially coaxially surrounding the first vessel (6), and being coupled to the first vessel (6) via the two end sections (20),
and the second vessel (22) comprising a polymer material, or the second vessel (16) comprising a glass material, and being at least partially coated with an infrared reflective material (18) on the side facing the first vessel (6).

2. A low-pressure mercury vapor discharge lamp according to claim 1, characterized in that the infrared-reflective material comprises TiO₂, NbO₂ or SnO₂.

3. A low-pressure mercury vapor discharge lamp according to claim 2, characterized in that the infrared-reflective material comprises SnO2:F.

4. A low-pressure mercury vapor discharge lamp according to claim 1, characterized in that the coating of infrared-reflective material is formed as a plurality of layers.

5. A low-pressure mercury vapor discharge lamp according to claim 1, characterized in that the polymer material comprises an acrylic compound.

6. A low-pressure mercury vapor discharge lamp according to claim 1, characterized in that the first vessel is coupled to the second vessel in a gastight manner, and a space between the first vessel and the second vessel is filled with a gas comprising carbon dioxide.
